(19) United States
(12) Patent Application Publication
(10) Pub. No.: US 2026/0138280 A1
(43) Pub. Date: May 21, 2026

(54) INTEGRATED VISION AND ROBOT CONTROL SYSTEM

(71) Applicant: ROCKWELL AUTOMATION TECHNOLOGIES, INC., MAYFIELD HEIGHTS, OH (US)

(72) Inventors: Bhanu K. Gouda, Reminderville, OH (US); Sivaram Balasubramanian, Solon, OH (US)

(21) Appl. No.: 19/340,337

(22) Filed: Sep. 25, 2025

Related U.S. Application Data
(60) Provisional application No. 63/721,831, filed on Nov. 18, 2024.

(51) Int. Cl. B25J 9/16

(52) U.S. Cl. CPC B25J 9/1697; B25J 9/1664; B25J 9/1674

(57) ABSTRACT

Systems, devices, methods, and media that can be used to provide integrated vision and robot control functionality in a variety of applications. An example control device includes memory and processing circuity configured to execute instructions in the memory to execute a hybrid motion planning process for a robot; perform a safety check to validate a motion plan for the robot; execute the motion plan to control the robot in accordance with the motion plan; and, while executing the motion plan, receive vision data associated with the robot and adjust the motion plan based on the vision data.

### CROSS-REFERENCE TO RELATED APPLICATION

This application claims the benefit of and priority to U.S. Provisional Ser. No. 63/721,831 filed Nov. 18, 2024, the entirety of which is incorporated by reference herein.

### BACKGROUND INFORMATION

The present disclosure relates generally to systems, devices, methods, and media that can be used for integrated vision and robot control in various applications. For example, the systems, devices, methods, and media detailed herein can be used in industrial control systems in industries such as aerospace, automotive, cement, chemical processing, food and beverage, household and personal care, life sciences, marine operations, metals processing, mining operations, oil and gas, power generation, print and publishing, pulp and paper, semiconductor fabrication, warehouse and fulfillment, and wastewater treatment, among others.

### BRIEF DESCRIPTION

One aspect of the present disclosure is a control device. The control device includes memory and processing circuitry, where the processing circuitry is configuration to execute instructions stored in the memory to execute a hybrid motion planning process to generate a motion plan for a robot by synchronizing data generated by an internal motion planning system with data generated by an external motion planning system; perform a safety check to validate the motion plan for the robot based on a set of safety constraints; execute the motion plan to control the robot in accordance with the motion plan responsive to determining that the motion plan passes the safety check; and, while executing the motion plan, receive vision data associated with the robot and adjust the motion plan based on the vision data.

Another aspect of the present disclosure is a method. The method includes executing, by a control device, a hybrid motion planning process to generate a motion plan for a robot by synchronizing data generated by an internal motion planning system with data generated by an external motion planning system; performing, by the control device, a safety check to validate the motion plan for the robot based on a set of safety constraints; executing, by the control device, the motion plan to control the robot in accordance with the motion plan responsive to determining that the motion plan passes the safety check; and, while executing the motion plan, receiving, by the control device, vision data associated with the robot and adjusting, by the control device, the motion plan based on the vision data.

Yet another aspect of the present disclosure is a non-transitory computer-readable storage medium. The non-transitory computer-readable storage medium has instructions stored thereon that, when executed by processing circuitry, cause the processing circuitry to execute a hybrid motion planning process to generate a motion plan for a robot by synchronizing data generated by an internal motion planning system with data generated by an external motion planning system; perform a safety check to validate the motion plan for the robot based on a set of safety constraints; execute the motion plan to control the robot in accordance with the motion plan responsive to determining that the motion plan passes the safety check; and, while executing the motion plan, receive vision data associated with the robot and adjust the motion plan based on the vision data.

### BRIEF DESCRIPTION OF THE DRAWINGS

FIG. 1 is a block diagram illustrating components of an example control system, in accordance with some aspects of the disclosure.

FIG. 2 is a flow diagram illustrating an example control process that can be performed by a control device that is part of the control system of FIG. 1, in accordance with some aspects of the disclosure.

FIG. 3 is an illustration of an example user interface that can be used to configure a control device that is part of the control system of FIG. 1, in accordance with some aspects of the disclosure.

FIG. 4 is a flow diagram illustrating another example control process that can be performed by a control device that is part of the control system of FIG. 1, in accordance with some aspects of the disclosure.

FIG. 5 is a flow diagram illustrating an example vision process that can be performed by a control device that is part of the control system of FIG. 1, in accordance with some aspects of the disclosure.

FIG. 6 is a flow diagram illustrating an example hybrid motion planning process that can be performed by a control device that is part of the control system of FIG. 1, in accordance with some aspects of the disclosure.

FIG. 7 is a flow diagram illustrating an example safety process that can be performed by a control device that is part of the control system of FIG. 1, in accordance with some aspects of the disclosure.

FIG. 8 is a flow diagram illustrating an example state machine that can be implemented by a control device that is part of the control system of FIG. 1, in accordance with some aspects of the disclosure.

### DETAILED DESCRIPTION

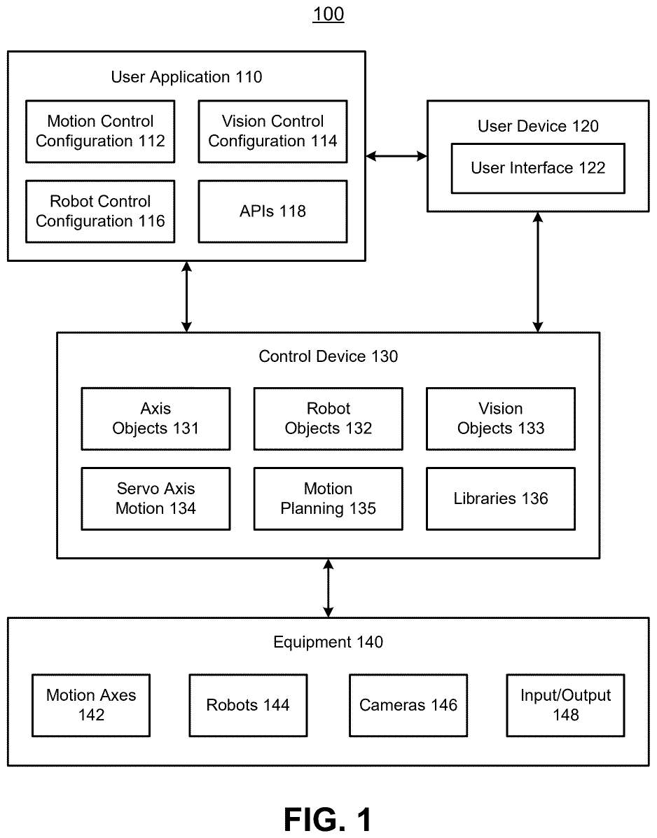

Referring to FIG. 1, a block diagram illustrating components of an example control system 100 is shown, in accordance with some aspects of the disclosure. As shown, the control system 100 can include, among other possible components, a user application 110, a user device 120, a control device 130, and equipment 140. The user application 110 can be configured to generate and cause a user interface 122 to be presented on the user device 120, where the user interface 122 can be used by a user to configure various parameters associated the control device 130 and/or other components of the control system 100. The control device 130 can be used to control the equipment 140 in the control system 100 (e.g., by receiving data from and sending control signals to the equipment 140, etc.).

The user device 120 can be implemented using any suitable type of computing device. For example, the user device 120 can be a personal computing device, such as, for example, a laptop, a desktop computer, a tablet, a smartphone, and/or other types of personal computing devices. The user device 120 can also be a workstation computing device that is located in a manufacturing facility for use by engineers and other skilled personnel (e.g., a human machine interface (HMI) device, a workstation computer, etc.). The user device 120 can include various suitable types of processing circuitry (e.g., one or more central processing units (CPUs), one or more graphics processing units (GPUs), etc.) and memory (e.g., volatile, non-volatile, random-access memory (RAM), read-only memory (ROM), electrically erasable programmable read-only memory (EEPROM), etc.).

The user device 120 can include one or more non-transitory machine-readable storage media having instructions stored thereon that, when executed by the processing circuitry of the user device 120, cause the processing circuitry of the user device 120 to perform various operations in accordance with the instructions. The user device 120 can generally access the user application 110 (e.g., through a web browser executing on the user device 120, through an application installed on the user device 120, etc.) in a manner such that the user application 110 can cause the user interface 122 to be presented via the user device 120. The user interface 122 can be implemented as any suitable type of user interface, including a web interface (e.g., presented via a web browser), an application interface (e.g., a mobile application, a desktop application, etc.), etc.

The user application 110 can generally be used by one or more users to generate, access, modify, download, verify, and/or perform other functions in relation to one or more control programs for execution by the control device 130. The user application 110 can also be used to perform various other operations that are associated with the control system 100. The user application 110 can be implemented as a software application that is hosted on one or more server computers and/or downloaded on the user device 120. The one or more server computers can be implemented in a variety of ways, including using multiple separate devices in communication with one another, or as a standalone system or device. For example, the one or more server computers can be implemented using one or more remote server computers operating in a data center (e.g., cloud-based servers), one or more on-premises server computers (e.g., server computers installed at a manufacturing facility), or a combination thereof (e.g., a hybrid implementation). The user application 110 can include Studio 5000® Design Software as provided by Rockwell Automation, Inc., for example.

The control device 130 can likewise be implemented using various suitable types of control devices. For example, the control device 130 can be implemented as a programmable logic controller (PLC), as an application-specific integrated circuit (ASIC) based control device, and/or implemented as an industrial personal computing device. The control device 130 can include various suitable types of processing circuitry (e.g., CPUs, GPUs etc.) and memory (e.g., volatile, non-volatile, RAM, ROM, EEPROM, etc.), where the memory can store instructions that are executable by the processing circuitry to cause the processing circuitry to perform operations. The control device 130 can include one or more non-transitory machine-readable storage media having instructions stored thereon that, when executed by the processing circuitry of the control device 130, cause the processing circuitry the control device 130 to perform various operations in accordance with the instructions.

The processing circuitry of the control device 130 can include specialized cores that have an affinity to specific tasks. For example, the processing circuitry of the control device 130 can include one or more CPU cores and/or one or more GPU cores that are specifically dedicated to performing vision functions (e.g., as detailed below), and one or more CPU cores and/or one or more GPU cores that are specifically dedicated to performing robot motion planning functions (e.g., both internal and external, as detailed below). This design choice can provide flexibility in selecting hardware components that are customized to meet the specific needs of the application. For example, this design choice can allow complex image processing tasks to be executed without affecting the real-time control of the equipment 140. The ability to offload vision processing tasks to dedicated hardware components of the control device 130 (e.g., one or more specific CPU cores, etc.) can enhance the overall performance of the control device 130 and the control system 100 more broadly.

The equipment 140 can include any suitable equipment in the control system 100 that can be controlled by the control device 130 and/or can be in communication with the control device 130. For example, as shown in FIG. 1, the equipment 140 can include one or more motion axes 142, one or more robots 144, one or more cameras 146, and input/output (I/O) devices 148. The motion axes 142 can include any suitable types of motion axes such as conveyers and pumps, for example. The robots 144 can include any suitable types of robots such as delta robots, selective compliance assembly robot arms or selective compliance articulated robot arms (SCARA robots), delta robots, and six-axis robots, for example. The cameras 146 can likewise include any suitable types of cameras such as two-dimensional (2D) cameras (e.g., charge-coupled device (CCD) cameras, complementary metal-oxide semiconductor (CMOS) cameras, etc.), three-dimensional (3D) cameras, ultrasonic (sonar) cameras, infrared (IR) cameras, line cameras, RGBD cameras, and stereo cameras, for example. The cameras 146 can generally generate vision data and provide the vision data to the control device 130. The cameras can also receive instructions from the control device 130 (e.g., camera configuration parameters, etc.). Also, the control device 130 can send controls signals to the motion axes 142 and the robots 144 to affect the operation of the motion axes 142 and the robots 144, respectively.

The components of the control system 100 can communicate with each other via various suitable wired and/or wireless communications networks and protocols (e.g., Ethernet/IP, universal serial bus (USB), GigE Vision, Wi-Fi, etc.). The I/O devices 148 can include various suitable types of I/O devices including safety I/O devices, general purpose I/O devices, and/or any other suitable types of I/O devices that may be used in an industrial automation environment. The equipment 140 can further include safety systems and devices (e.g., safety controllers, safety PLCs, emergency stop devices, etc.), general purpose controllers (e.g., general purpose PLCs), HMI devices, variable frequency drives (VFDs), servo drives, and/or other suitable types of equipment.

The control device 130 can be specifically designed to integrate vision systems and robot motion planning technology into a single device to serve a broad spectrum of application and address a need in the technical field of industrial control systems for improved automation, precision, and efficiency. The control device 130 can provide a unified automation solution with advanced capabilities by combining vision functionality with both internal and third-party robotic motion planning technologies. The control device 130 can thus provide a unique solution for complex, high speed, precision motion applications that has not existed on the market previously. For example, the control device 130 can be used in high-speed machine applications (e.g., packaging application, etc.) where robots, information and communications technology systems, and general motion axes all work together within the same control application that is executed by the control device 130 and configured via the user application 110. The control device 130 can also be used in “scan and plan” applications such as painting, surface finishing, deburring, and inspection, for example. Further, the control device 130 can be used in high mix, low volume manufacturing applications (e.g., bin picking, etc.), human-robot collaboration applications (e.g., dynamic collision avoidance, etc.), and kinematics and motion planning applications for higher degrees of freedom robots (e.g., complex manipulation for advanced pick and place operations, etc.). The control device 130 can consist essentially of a single device that is contained within a housing.

Further, the control device 130 can allow unified vision and robot control programming of the control device 130 via the user application 110. The control device 130 can also provide integrated vision functionality for non-robotics operations (e.g., general motion operations, integrated control operations, pushers, diverters, I/O, process control, etc.). The control device 130 can further provide collision-free multi-robot control functionality and enable hybrid simulations with decoupled vision and robot components. For example, by implementing decoupled vision and robotic application components within the control system 100, it can become feasible to simulate either one component or both based on application requirements. The vision component can be simulated with a physical robot by using a camera recording of the raw image captures to perform image processing and train physical robots effectively in picking up and placing items with precision. The robot component can be simulated by using a live camera feed in conjunction with a virtual robot to validate the correct calibration of the camera and ensure that objects can be picked up by the physical robot without causing damage.

The user application 110 is shown to include a motion control configuration component 112, a vision control configuration component 114, a robot control configuration component 116, and application programming interfaces (APIs) 118. The motion control configuration component 112 can allow a user to configure various aspects of motion control functionality (e.g., control of the motion axes 142) performed by the control device 130 via the user interface 122 presented on the user device 120. For example, the motion control configuration component 112 can allow the user to configure motion servo on (MSO) instructions, message (MSG) instructions, motion group stop (MGS) instructions, motion axis move (MAM) instructions, motion axis jog (MAJ) instructions, motion axis position cam (MAPC) instructions, motion axis gear (MAG) instructions, turn on/off axis instructions, move axis instructions, jog axis instructions, and/or other suitable types of instructions used for motion control. Then, the vision control configuration component 114 can allow the user to configure various instructions pertaining to vision data collection (e.g., control of the cameras 146) performed by the control device 130 via the user interface 122 presented on the user device 120. For example, the vision control configuration component 114 can allow the user to configure object detection instructions, image capture instructions, read image instructions, and/or other types of instructions pertaining to vision data collection. In some examples, the vision control configuration component 114 can allow the user to configure various instructions pertaining to vision data collection in accordance with the International Electrotechnical Commission (IEC) 61131 standards.

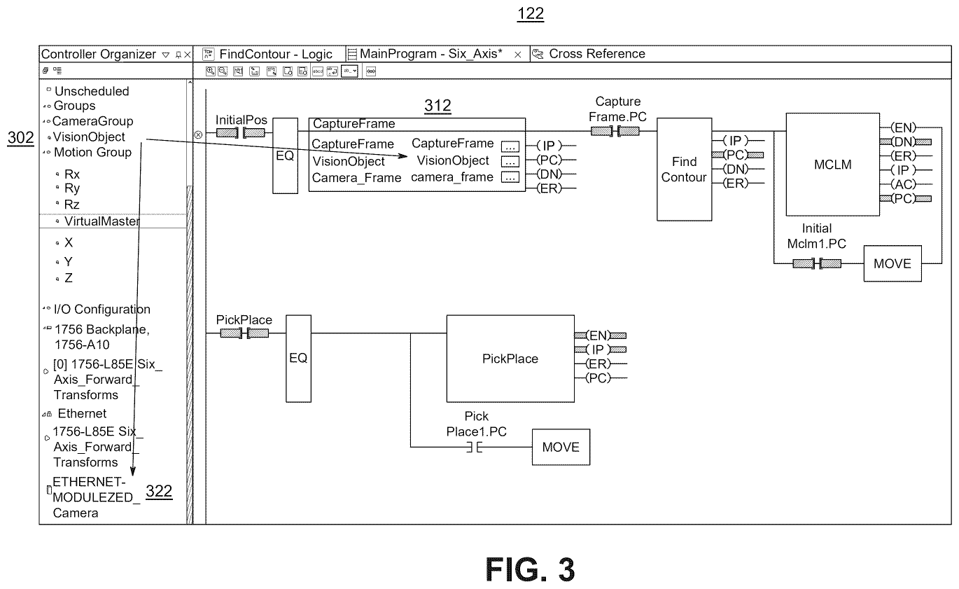

The robot control configuration component 116 can allow a user to configure various aspects of robot control functionality (e.g., control of the robots 144) performed by the control device 130 via the user interface 122 presented on the user device 120. For example, the robot control configuration component 116 can allow the user to configure enable robot instructions, move linear absolute instructions, read frame data instructions, and/or other suitable types of instructions used for robot control. The motion control configuration component 112, the vision control configuration component 114, and the robot control configuration component 116 can allow the user to manage these configurations via ladder logic (e.g., as shown in FIG. 3) and/or via structured text instructions sets, for example. The APIs 118 can include any suitable types of APIs (e.g., Python APIs, C++ APIs, etc.) for interfacing with external, third-party systems to aid in programming of the control device 130. The external systems can include external libraries, external motion planning systems, and/or other possible types of external systems.

The control device 130 is shown to include one or more axis objects 131, one or more robot objects 132, and one or more vision objects 133. The axis objects 131 can be configured via the user application 110 (e.g., via the motion control configuration component 112) and can define one or more attributes associated with the motion axes 142. The axis objects 131 can be read and acted upon by one or more control programs executed by the control device 130 to manage the control of the motion axes 142. The robot objects 132 can be configured via the user application 110 (e.g., via the robot control configuration component 114) and can define one or more attributes associated with the robots 144. The robot objects 132 can be read and acted upon by one or more control programs executed by the control device 130 to manage the control of the robots 144. The vision objects 133 can be configured via the user application 110 (e.g., via the vision control configuration component 116) and can define one or more attributes associated with the cameras 146. The vision objects 133 can be read and acted upon by one or more control programs executed by the control device 130 to manage the control of the cameras 146. The axis objects 131, the robot objects 132, and the vision objects 133 can be implemented as Common Industrial Protocol (CIP) objects, for example, among other possibilities.

The control device 130 is also shown to include a servo axis motion component 134, a motion planning component 135, and libraries 136. The servo axis motion component 134 can manage and maintain one or more motion profiles used to control the motion axes 142. For example, the servo axis motion component 134 can manage and maintain trapezoidal motion profiles, S-curve motion profiles, VDI profiles, and/or CAMs. The motion planning component 135 can generate motions plans for the robots 144. For example, the motion planning component 135 can use kinematics, trajectory planning, and/or dynamic modeling approaches to generate motions plans for the robots 144. The motion planning component 135 can, in some examples, use an external planning process instead of or in addition to an internal motion planning process to generate motions plans for the robots 144. The servo axis motion component 134 and the motion planning component 135 can work in conjunction such that the control device 130 executes a combined motion plan for the motion axes 142 and the robots 144 to avoid collisions. The libraries 136 can include various suitable libraries that can be used to provide various tools for the control device 130. For example, the libraries 136 can include an OpenCV library, a MoveIt library, and/or other Robot Operating System (ROS) libraries, etc. The components of the control device 130 as shown in FIG. 1 are examples, and it should be noted that the control device 130 can include more, fewer, and/or alternative components besides those shown in FIG. 1. For example, the control device 130 can additionally include an integrated control engine that executes a control program (e.g., as configured via the user application 110). Also, the control device 130 can include an equipment configuration that defines how equipment parameters have been configured (e.g., the I/O devices 148, drive configurations, etc.) for the control application.

The control system 100 can provide a variety of advantages in various applications. The control system 100 can be used to flexibly integrate vision capabilities with a variety of internal and external robotics technologies. Both manufacturers (e.g., end users) and Original Equipment Manufacturers (OEMs) can benefit from the more straightforward, integrated solution provided by the control system 100 because the control system 100 allows them to standardize on a single programming platform for both vision and robot control. The integration of vision and robot control into a centralized solution like provided by the control system 100 can reduce latency, thereby leading to quicker decision making processes and improved response times. Additionally, the control system 100 can allow for streamlined hardware setup and maintenance processes. By using the techniques discussed herein, the vendor of the control device 130 can provide control of an entire machine including robotics, general motion, standard and safety I/O (e.g., redundant I/O), and vision with a single programming environment. Additionally, by using the techniques discussed herein, the vendor of the control device 130 can provide flexibility to choose or combine internal and external motion planning technologies.

For example, the control device 130 can be a single device that is capable of managing multiple robots with integrated vision and also capable of being used in various user applications to streamline a wide array of automation tasks. These tasks can involve product inspection for defect identification and inventory management through barcode or QR code data scanning, for example. In some previous approaches, an industrial personal computer that is connected to a camera for image processing can be used to send pass-fail outcomes to a PLC, and then the PLC can accept or reject products from a production line based on the pass-fail outcomes received from the industrial personal computer. However, by using the techniques described herein, the industrial personal computer can be eliminated, and the PLC (e.g., the control device 130) can handle all of the operations performed by the industrial personal computer.

Additionally, in some previous approaches, multiple robots of different geometries (e.g., six-axis robot, SCARA robot, delta robot) may not be capable of sharing a common workspace without collisions if they are run simultaneously from the same PLC. However, the control system 100 has the ability to plan and synchronize all of the robot movements more efficiently, thereby reducing collisions. The control system 100 can achieve this synchronization through the use of vision data, internal and/or external motion planning capabilities, and user programmable logic. The functionality provided by the control system 100 can complement the single robot collision-free motion planning from obstacles.

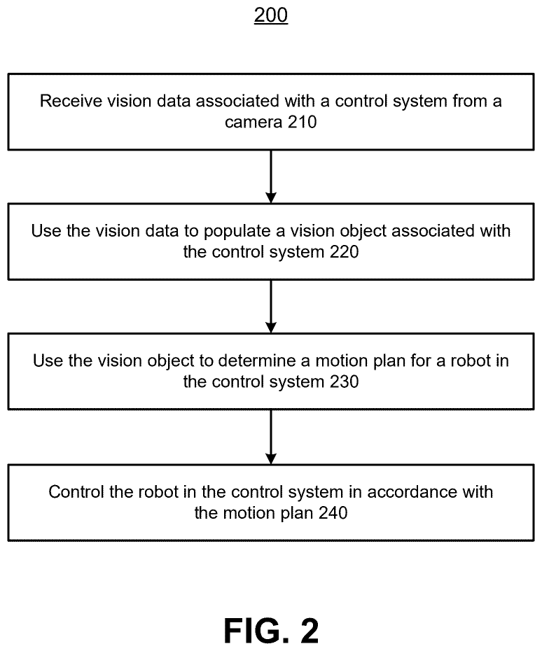

Referring to FIG. 2, a flow diagram illustrating an example control process 200 that can be performed by the control device 130 as part of the control system 100 is shown, in accordance with some aspects of the disclosure. The process 200 can generally be performed using the control system 100, as detailed above. For example, the process 200 can be performed by the control device 130 in conjunction with the equipment 140 and based on configurations provided by user via the user device 120 that accesses the user application 110 to present the user interface 122 on the user device 120. The process 200 can generally provide advantages in terms of flexibly integrating vision and motion control in a single control device (e.g., a single PLC, such as the control device 130) with other process control functionality (e.g., discrete, standard, redundant safety, etc.). The process 200 can be used to provide a perception driven closed loop solution in various applications. For example, the process 200 can be used to control high speed delta robots tracking a running conveyor with detected objects from a vision camera, where the conveyor tacking is handled with superimposed motion using general motion commands.

At 210, the process 200 can include receiving vision data associated with a control system from a camera. For example, the control device 130 can receive vision data associated with the control system 100 via one of the cameras 146. The control device 130 can receive the vision data using various suitable wireless and/or wired communications networks using various suitable protocols. The camera can be any suitable type of camera, such as a 2D cameras (e.g., a CCD camera, a CMOS camera, etc.), a 3D camera, an ultrasonic (sonar) camera, an IR camera, a line camera, an RGBD camera, or a stereo camera, for example. The vision data can be received at 210 in accordance with the vision control configuration 114. The vision data can be indicative of the position and/or identity (e.g., color, shape, barcode, etc.) of objects manipulated by the robots 144, for example. The objects can be provided in a work area (e.g., a conveyor, a table, etc.) and can be identified by the control device 130 based on various types of unique visual features.

At 220, the process 200 can include using the vision data to populate a vision object associated with the control system. For example, the control device 130 can use the vision data received at 210 to populate one of the vision objects 133 associated with the control system 100. The vision object can be a CIP vision object that is agnostic of the specific type of camera that generated the vision data. Accordingly, the use of the vision object can allow the control device 130 to be used with any of a variety of different types of cameras, depending on the application. The vision object can be used to invoke vision functions such as a capture frame function and a find contour function, for example, in line with other functions performed by the control device 130. For example, FIG. 3 provides an illustration showing an example of the user interface 122, in accordance with some aspects of the disclosure. As shown, a vision object 302 can be used to invoke a capture frame function 312 in line with other functions, and the vision object 302 can be associated with a camera device 322.

At 230, the process 200 can include using the vision object to determine a motion plan for a robot in the control system. For example, the control device 130 can invoke the vision object using the motion planning component 135 to determine a motion plan for one of the robots 144 in the control system 100. The motion planning component 135 can leverage the libraries 136 to determine the motion plan at 230 in some examples. As such, the motion planning component 135 can leverage internal motion planning technologies (e.g., logic configured via the user application 110) and/or external motion planning technologies (e.g., open source technologies developed by third parties) to determine the motion plan for the robot at 230. The external planning process can include planning collision-free robot motion and streaming position data for the joints of the robot, for example. Due to the integration of vision and motion control in the control device 130, the control device 130 can determine the motion plan at 230 in a manner that synchronizes the robot movements with movements of other robots and/or other motion components in the same workplace, thereby reducing collisions.

At 240, the process 200 can include controlling the robot in the control system in accordance with the motion plan. For example, the control device 130 can send one or more control signals to the robot to control the robot in accordance with the motion plan determined at 230. The control device 130 can send the control signals to the robot using various suitable wireless and/or wired communications networks using various suitable protocols. The control device 130 can also apply superimposed motion to other robots and auxiliary motion axes in the same machine. The control device 130 can also use the vision object to control standard and/or safety I/O in the machine (e.g., the I/O devices 148).

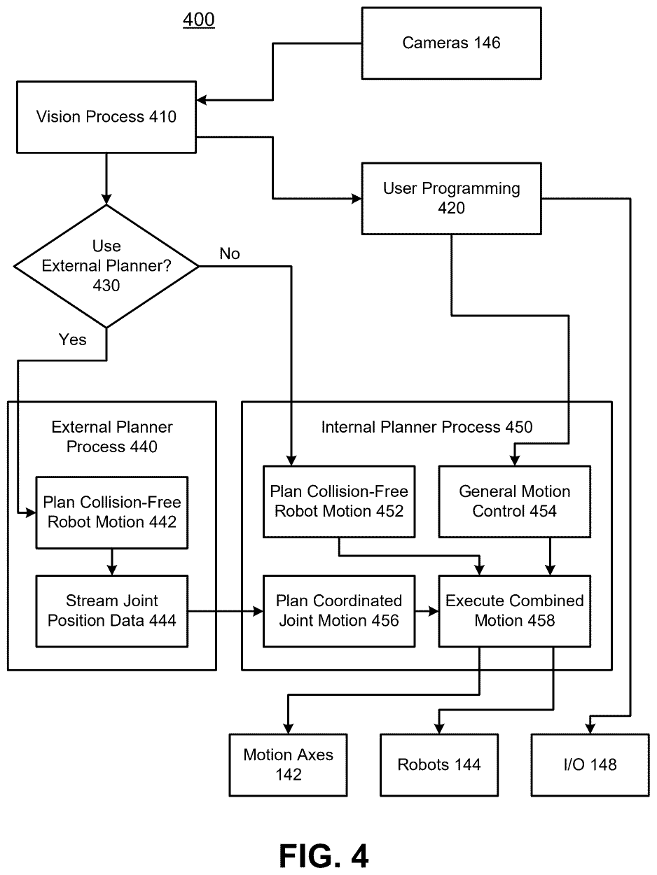

Referring to FIG. 4, a flow diagram illustrating another example control process 400 that can be performed the control device 130 as part of the control system 100 is shown, in accordance with some aspects of the disclosure. The process 400 can provide a perception-driven closed loop solution in a variety of motion control applications to provide integrated robot vision and control. At 410, the process 400 can include executing a vision process based on data received from the cameras 146. The vision process executed at 410 can generally include processing images generated by the cameras 146 and populating objects based on the images generated by the cameras 146. For example, the control device 130 can process the images from the cameras 146 and populate the vision objects 133. The attributes of the vision objects 133 can contain information such as object position, object color, object shape, object barcode information, and other possible types of information.

Then, at 420, the process 400 can include receiving vision inputs at a user application. For example, the process 400 can include sending the vision objects 133 that are populated as a result of executing the vision process at 410 to the user application 110. This functionality can allow the user application 110 to perform various types of control functions based on the vision objects 133 based on configurations generated by users (e.g., via the user interface 122 on the user device 120). For example, the user application 110 can be used by one or more users to generate, access, modify, download, verify, and/or perform other functions in relation to one or more control programs for execution by the control device 130 based on the vision objects 133. For example, the user application 110 can allow users to configure various instructions pertaining to vision data collection in accordance with the IEC 61131 standards. These instructions can include various types of commands including MSO instructions, MSG instructions, MGS instructions, MAM instructions, MAJ instructions, MAPC instructions, MAG instructions, turn on/off axis instructions, move axis instructions, jog axis instructions, and/or other suitable types of instructions used for motion control. The configuration via the user application 110 can include programming for controlling and coordinating auxiliary axes of the motion axes 142, for example. The programming via the user application 110 at 420 can also be used to control the I/O devices 148, as shown in FIG. 4.

Next, at 430, the process 400 can include determining whether or not to use an external motion planning system. In some examples, the external motion planning system can be a system that is separate from the control device 130 (e.g., software executing on a separate workstation, software executing on a local server, software executing on a cloud system, etc.) as compared to an internal motion planning system that includes software local to the control device 130 (e.g., stored in a memory of the control device 130 and executed by processing circuitry of the control device 130). However, in other examples, the external motion planning system can also be a second motion planning system that is provided on the control device 130 itself in addition to the internal motion planning system (e.g., a first motion planning system). In these examples, the external motion planning system (the second motion planning system) can be associated with an entity different from the entity that manufactures and/or provides the control device 130. For example, the external motion planning system (the second motion planning system) can be an open source motion planning system or an OEM-specific motion planning system that is provided on the control device 130 along with the internal motion planning system (the first motion planning system).

The control device 130 can make the decision at 430 based on a variety of factors including task complexity, computational resource requirements, timing constraints, data source requirements, control architecture design choices, and/or safety standards and other safety considerations. For example, the control device 130 can decide to use the external motion planning system for higher-level tasks that require more global optimization (e.g., coordination with other robots and/or machines, etc.) and to use the internal motion planning system for more local, well-defined tasks (e.g., point-to-point motion, collision-free path generation in a known working environment, etc.). If the control device 130 does decide to use the external motion planner at 430, the control device 130 can use the external motion planning system in combination with the internal motion planning system, in some examples.

Then, at 440, if the control device 130 does decide to use the external motion planning system at 430, the process 400 can include transmitting data associated with the equipment 140 to the external motion planning system such that the external motion planning system can use the data associated with the equipment 140 to perform an external planner process 440. Then, once the external motion planning system performs the external planner process 440, the external motion planning system can send motion planning data back to the control device 130 such that the control device 130 can use the motion planning data from the external motion planning system to control the equipment 140. In examples where the external motion planning system (the second motion planning system) is provided on the control device 130 itself, the proves 400 can more simply include providing data associated with the equipment 140 to the external motion planning system (the second motion planning system) and receiving motion planning data back from the external motion planning system (the second motion planning system) without requiring any transmission or reception of data outside of the control device 130. As shown in FIG. 4, the external planner process 440 can include planning collision-free robot motion at 442 and streaming joint position data back to the control device 130 at 444. The external planner process 440 can perform the planning of collision-free robot motion at 442 in a variety of manners, and can also stream the joint position data such that the joint position data is usable by the control device 130 at 444 in a variety of manners such that the control device 130 can use the streamed joint position data to control the equipment 140.

Next, at 450, if the control device 130 does not decide to use the external motion planning system at 430, the process 400 can include using data associated with the equipment 140 to perform an internal planner process 450. As shown in FIG. 4, the internal planner process 450 can include planning collision-free robot motion at 452 and performing general motion control at 454. Also, if the internal planner process 450 operates in connection with the external planner process 440, the internal planner process 450 can also include planning coordinated joint motion at 456 and executing combined (hybrid) motion at 458. For example, as shown in FIG. 4, the control device 130 can execute a motion plan that is generated using the external planner process 440 and/or the internal planner process 450 to control the motion axes 142 and/or the robots 144 (e.g., by sending control signals to the motion axes 142 and/or the robots 144, by operating servos associated with the motion axes 142 and/or the robots 144, etc.).

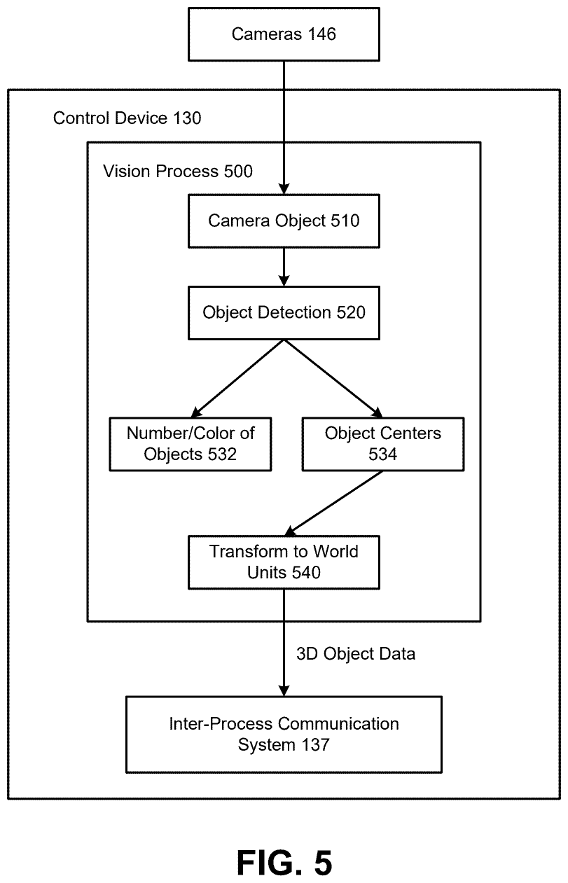

Referring to FIG. 5, a flow diagram illustrating an example vision process 500 that can be performed the control device 130 as part of the control system 100 is shown, in accordance with some aspects of the disclosure. The vision process 500 generally illustrates aspects of a vision and perception pipeline that can be implemented in the control system 100. As shown, the cameras 146 can feed raw image data into this pipeline. As part of the vision process 500, the control device 130 can generate and maintain a camera object 510, and use the camera object 510 to initialize a respective one of the cameras 146. The control device 130 can use the camera object 510 to capture synchronized stereo image frames (e.g., left and right side images), add timestamps to the synchronized stereo image frames, and apply calibration parameters to the synchronized stereo image frames. Then, as part of the vision process 500, the control device 130 can perform an object detection process 520 to perform image preprocessing, segmentations, and classification, as well as to identify objects of interest in particular scenes.

As a result of performing the object detection process 520, the control device 130 can record extracted features as outputs as part of the vision process 500. For example, as shown in FIG. 5, the control device 130 can record a number and/or color of detected objects 532 and object centers 534 (e.g., as determined in pixel space). The control device 130 can also record object types associated with any detected objects and any other visual or other information associated with the detected objects. Next, as part of the vision process 500, the control device 130 can perform a transformation process 540 to generate outputs indicative of real-world object positions. For example, the control device 130 can convert pixel coordinates to metric units using camera calibration data to generate 3D coordinates associated with detected objects. In some examples, the control device 130 can then send this 3D object data to an inter-process communication system (IPC) 137. The IPC 137 can include shared memory and messaging functionality to facilitate cooperation between components of the control device 130 and, in some examples, the control system 100 more broadly, for example.

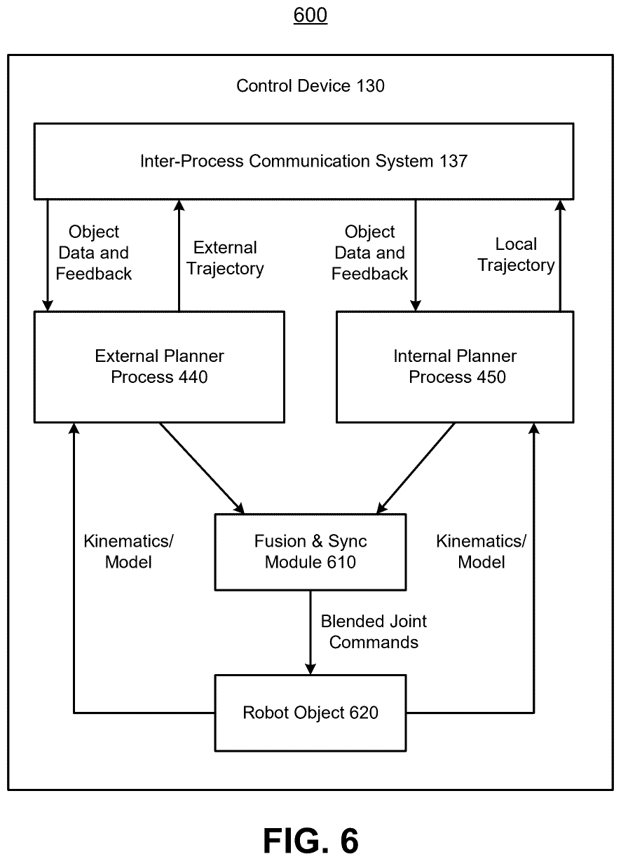

Referring to FIG. 6, a flow diagram illustrating an example hybrid motion planning process 600 that can be performed on the control device 130 as part of the control system 100 is shown, in accordance with some aspects of the disclosure. The hybrid motion planning process 600 can be used to generate a motion plan for one of the robots 144 by synchronizing data that is generated by an internal motion planning system with data that is generated by an external motion planning system. As shown, as part of the hybrid motion planning process 600, the control device 130 can generate and maintain a robot object 620 to provide data associated with a particular robot to both the external planner process 440 and the internal planner process 450. The control device 130 can use the robot object 620 to maintain a kinematic model associated with the robot (e.g., model parameters in Unified Robot Description Format (URDF), Denavit-Hartenberg (DH) Parameters, etc.), to maintain joint states associated with the robot, to maintain actuator interfaces associated with the robot, and/or to maintain other information associated with the robot.

Additionally, to facilitate performance of the hybrid motion planning process 600, the control device 130 can include a fusion and synchronization module 610. The fusion and synchronization module 610 can be implemented as a software module, for example, that synchronizes data generated by the internal motion planning system with data generated by the external motion planning system. For example, the fusion and synchronization module 610 can perform downsampling or upsampling of the data generated by the internal motion planning system or data generated by the external motion planning system. The fusion and synchronization module 610 can also perform timestamp adjustments, command fusions, and/or other functions to blend the joint commands generated via the external planner process 440 and the internal planner process 450. The external planner process 440 can, in some examples, produce outputs that are coarse, timestamped joint trajectories with collision planning. The external planner process 440 and the internal planner process 450 can communicate joint trajectories and other types of motion plans to the IPC 137.

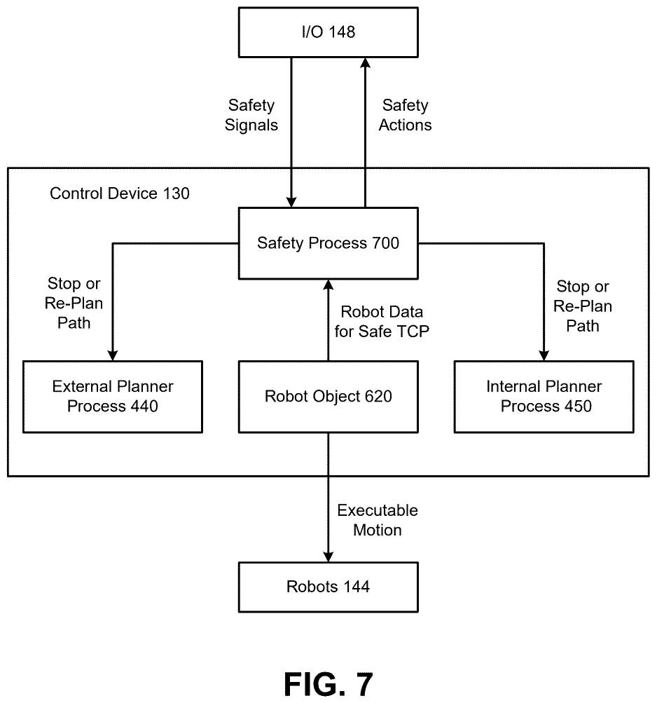

Referring to FIG. 7, a flow diagram illustrating an example safety process 700 that can be performed by the control device 130 as part of the control system 100 is shown, in accordance with some aspects of the disclosure. The safety process 700 can be used to ensure that any motion plans generated by the control device 130 satisfy various safety constraints that may be associated with the control system 100. The safety process 700 can include monitoring of the I/O devices 148 (e.g., safety I/O devices including e-stops, light curtains, etc.), determining a tool center point (TCP) speed and position associated with a particular one of the robots 144, monitoring physical boundaries (e.g., keep in/keep out zones) associated with the robot, and monitoring various limits (e.g., joint position limits, acceleration limits, torque limits, etc.) associated with the robot. Also, the safety process 700 can include generating and sending safety commands to the I/O devices 148 (e.g., safe torque off, etc.) and causing a motion plan associated with the robot to stop executing or be re-planned, among other possible types of safety functionality. The safety process 700 can evaluate generated motion plans, receive data associated with the robot object 620, and interact with the external planner process 440 and the internal planner process 450. The safety process 700 can be implemented by the control device 130 to provide safety functionality in accordance with various safety performance levels, such as Safety Integrity Level 2 and/or Safety Integrity Level 3 (SIL2/SIL3), for example.

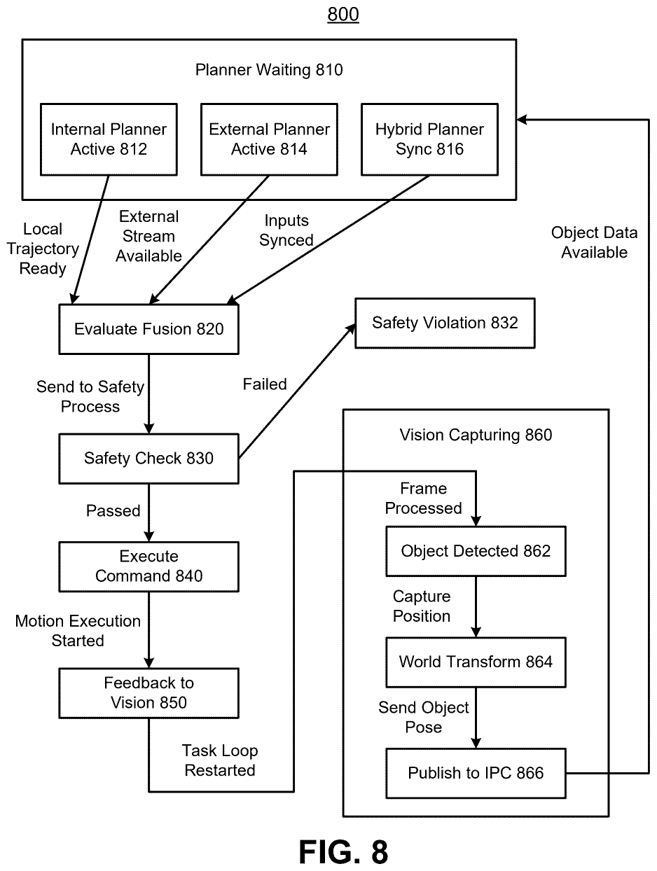

Referring to FIG. 8, a flow diagram illustrating an example state machine 800 that can be implemented by the control device 130 as part of the control system 100 is shown, in accordance with some aspects of the disclosure. The state machine 800 generally illustrates example behavior that can be implemented by the control device 130. More specifically, the state machine 800 illustrates a variety of states that can be experienced by the control device 130, and how the control device 130 transitions between the various states. For example, at a planner waiting state 810, the control device 130 can be waiting for an internal planner active indicator 812, an external planner active indicator 814, and/or a hybrid planner sync indicator 816 to be set. Then, at an evaluate fusion state 820, the control device 130 can evaluate a generated hybrid motion plan for a robot to determine if it is appropriately synchronized (e.g., as a result of executing the hybrid motion planning process 600). Next, at a safety check state 830, the control device 130 can perform a safety check to validate the generated hybrid motion plan for the robot based on a set of safety constraints. If the safety check fails, the control device 130 can transition to a safety violation state 832.

However, if the safety check passes, the control device 130 can transition to an execute command state 840, where the control device 130 can execute the generated hybrid motion plan to control the robot in accordance with the generated hybrid motion plan responsive to determining that the generated hybrid motion plan passes the safety check. Then, while the control device 130 executes the generated hybrid motion plan, the control device 130 can transition to a feedback to vision state 850, where the control device 130 initiates a vision process (e.g., the vision process 500). Then, while the control device 130 executes the generated hybrid motion plan, the control device 130 can transition to a vision capturing state 860. During the vision capturing state 860, the control device 130 can populate one or more of the vision objects 133. For example, during the vision capturing state 860, the control device 130 can detect an object at 862, perform a transformation at 864, and publish the vision object data to the IPC 137. When the control device 130 publishes new vision object data to the IPC 137, the control device 130 can use the new vision object data to adjust the current motion plan in real-time or to stop the execution of the current motion plan and invoke generation of a new motion plan.

It should be noted that while the steps/states of the process 200, the process 400, the vision process 500, hybrid motion planning process 600, the safety process 700, and the state machine 800 are shown in a particular order in FIG. 2, and FIGS. 4-8, respectively, the process 200, the process 400, the vision process 500, hybrid motion planning process 600, the safety process 700, and the state machine 800 may not include all steps/states shown, may include additional steps/states, or may include the steps/states in a different order.

This description uses examples to disclose the invention and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A control device, comprising:
memory comprising instructions; and
processing circuitry configured to execute the instructions to:
execute a hybrid motion planning process to generate a motion plan for a robot by synchronizing data generated by an internal motion planning system with data generated by an external motion planning system;
perform a safety check to validate the motion plan for the robot based on a set of safety constraints;
execute the motion plan to control the robot in accordance with the motion plan responsive to determining that the motion plan passes the safety check; and
while executing the motion plan:
receive vision data associated with the robot; and
adjust the motion plan based on the vision data.

2. The control device of claim 1, wherein the control device consists essentially of a single device that is contained within a housing.

3. The control device of claim 1, wherein the processing circuitry is configured to execute the instructions to synchronize the data generated by the internal motion planning system with the data generated by the external motion planning system by downsampling the data generated by the internal motion planning system or the data generated by the external motion planning system.

4. The control device of claim 1, wherein:
the vision data is indicative of a position of an object in a work area; and
the processing circuitry is configured to execute the instructions to adjust the motion plan based on the position of the object in the work area.

5. The control device of claim 4, wherein:
the vision data is indicative of a barcode on the object in the work area; and
the processing circuitry is configured to execute the instructions to adjust the motion plan based on the barcode on the object in the work area.

6. The control device of claim 1, wherein the set of safety constraints comprises:
physical boundaries associated with the robot;
joint position limits associated with the robot;
a payload capacity associated with the robot;
an acceleration limit associated with the robot; and
a torque limit associated with the robot.

7. The control device of claim 1, wherein:
the processing circuitry is configured to execute the instructions to populate a vision object associated with the robot based on the vision data; and
the vision object comprises attributes that are indicative of a position, a color, a shape, and a barcode associated with an object in a work area.

8. A method, comprising:
executing, by a control device, a hybrid motion planning process to generate a motion plan for a robot by synchronizing data generated by an internal motion planning system with data generated by an external motion planning system;
performing, by the control device, a safety check to validate the motion plan for the robot based on a set of safety constraints;
executing, by the control device, the motion plan to control the robot in accordance with the motion plan responsive to determining that the motion plan passes the safety check; and
while executing the motion plan:
receiving, by the control device, vision data associated with the robot; and
adjusting, by the control device, the motion plan based on the vision data.

9. The method of claim 8, wherein the control device consists essentially of a single device that is contained within a housing.

10. The method of claim 8, wherein synchronizing the data generated by the internal motion planning system with the data generated by the external motion planning system comprises upsampling the data generated by the internal motion planning system or the data generated by the external motion planning system.

11. The method of claim 8, wherein:
the vision data is indicative of a position of an object in a work area; and
adjusting the motion plan is based on the position of the object in the work area.

12. The method of claim 11, wherein:
the vision data is indicative of a shape of the object in the work area; and
adjusting the motion plan based on the shape of the object in the work area.

13. The method of claim 8, wherein the set of safety constraints comprises:
physical boundaries associated with the robot;
joint position limits associated with the robot;
a payload capacity associated with the robot;
an acceleration limit associated with the robot; and
a torque limit associated with the robot.

14. The method of claim 8, comprising populating, by the control device, a vision object associated with the robot based on the vision data, the vision object comprising attributes that are indicative of a position and a color of an object in a work area.

15. A non-transitory computer-readable storage medium having instructions stored thereon that, when executed by processing circuitry, cause the processing circuitry to:
execute a hybrid motion planning process to generate a motion plan for a robot by synchronizing data generated by an internal motion planning system with data generated by an external motion planning system;
perform a safety check to validate the motion plan for the robot based on a set of safety constraints;
execute the motion plan to control the robot in accordance with the motion plan responsive to determining that the motion plan passes the safety check; and
while executing the motion plan:
receive vision data associated with the robot; and
adjust the motion plan based on the vision data.

16. The non-transitory computer-readable storage medium of claim 15, wherein the instructions, when executed by the processing circuitry, cause the processing circuitry to synchronize the data generated by the internal motion planning system with the data generated by the external motion planning system by downsampling the data generated by the internal motion planning system or the data generated by the external motion planning system.

17. The non-transitory computer-readable storage medium of claim 15, wherein:
the vision data is indicative of a position of an object on a conveyor; and
the instructions, when executed by the processing circuitry, cause the processing circuitry to adjust the motion plan based on the position of the object on the conveyor.

18. The non-transitory computer-readable storage medium of claim 17, wherein:
the vision data is indicative of a color of an object on a conveyor; and
the instructions, when executed by the processing circuitry, cause the processing circuitry to adjust the motion plan based on the color of the object on the conveyor.

19. The non-transitory computer-readable storage medium of claim 15, wherein the set of safety constraints comprises:
physical boundaries associated with the robot;
joint position limits associated with the robot;
a payload capacity associated with the robot;
an acceleration limit associated with the robot; and
a torque limit associated with the robot.

20. The non-transitory computer-readable storage medium of claim 15, wherein:
the instructions, when executed by the processing circuitry, cause the processing circuitry to populate a vision object associated with the robot based on the vision data; and
the vision object comprises attributes that are indicative of a position and a barcode associated with an object on a conveyor.
